(19) United States
(12) Patent Application Publication
(10) Pub. No.: US 2026/0296581 A1
(43) Pub. Date: Oct. 1, 2026

(54) CARRYING VEHICLE

(71) Applicant: EXEDY Corporation, Osaka (JP)

(72) Inventors: Keisuke KISHIHARA, Osaka (JP); Katsuya FUJITA, Osaka (JP)

(21) Appl. No.: 19/549,953

(22) Filed: Feb. 25, 2026

(30) Foreign Application Priority Data
Mar. 25, 2025 (JP) 2025-049650

(51) Int. Cl. B62D 61/12

(52) U.S. Cl. CPC B62D 61/12

(57) ABSTRACT

An arm is attached to a frame in a manner movable up and down. A joint mechanism is attached to the arm. A movable member is attached to the frame in a manner movable up and down. An elastic member is disposed between the arm and the movable member. The first toggle mechanism includes a first link, a second link, and a first joint. The first link is attached to the movable member in a pivotable manner. The second link is attached to the frame in a pivotable manner. The first joint joins the first and second links therethrough to each other. An operating member switches the first toggle mechanism between the actuated state and the unactuated state. The first toggle mechanism moves the movable member upward when set in the actuated state. The first toggle mechanism moves the movable member downward when set in the unactuated state.

### CROSS-REFERENCE TO RELATED APPLICATIONS

This application is based on and claims the priority benefit of Japanese application No. 2025-049650 filed on Mar. 25, 2025, the contents of which are incorporated herein by reference.

### TECHNICAL FIELD

The present invention relates to a carrying vehicle.

### BACKGROUND

There has been proposed a carrying vehicle joined to a carried vehicle without a drive source such as a cart so as to carry the carried vehicle. For example, a carrying vehicle disclosed in Publication of Japan Patent No. 7040738 includes an electric motor and a drive wheel to be driven by the electric motor. Besides, the carrying vehicle includes a pressure receiving spring member for applying a wheel load to the drive wheel. The pressure receiving spring member urges the drive wheel toward the road surface so as to apply the wheel load to the drive wheel, whereby the drive wheel is prevented from idling.

### SUMMARY OF THE INVENTION

The carrying vehicle configured as described above has been demanded to be reduced in weight. However, when the carrying vehicle is reduced in weight, the wheel load to be applied to the drive wheel by the weight of the carrying vehicle is made insufficient, whereby the occurrence of idling of the drive wheel is concerned. In view of this, it is an object of the present invention to provide a carrying vehicle, in which it is made possible to apply a wheel load with a sufficient magnitude to a drive wheel.

A carrying vehicle according to a first aspect includes a frame, a drive wheel, a prime mover, an arm, a joint mechanism, a movable member, an elastic member, a first toggle mechanism, and an operating member. The drive wheel is attached to the frame in a rotatable manner. The prime mover is configured to drive the drive wheel. The arm is attached to the frame in a manner movable up and down. The joint mechanism is attached to the arm. The joint mechanism is configured to be joined to a carried vehicle. The movable member is attached to the frame in a manner movable up and down. The elastic member is disposed between the arm and the movable member. The first toggle mechanism is switchable between an actuated state and an unactuated state. The first toggle mechanism includes a first link, a second link, and a first joint. The first link is attached to the movable member in a pivotable manner. The second link is attached to the frame in a pivotable manner. The first joint joins the first and second links therethrough to each other. The operating member is configured to switch the first toggle mechanism between the actuated state and the unactuated state. The first toggle mechanism moves the movable member upward when set in the actuated state. The first toggle mechanism moves the movable member downward when set in the unactuated state.

According to the configuration, when the first toggle mechanism is set in the actuated state by the operating member, the movable member is moved upward, whereby the elastic member presses the arm upward. When the joint mechanism is herein joined to the carried vehicle, the joint mechanism and the arm are not moved upward due to the weight of the carried vehicle; hence, the elastic member is compressed to press the movable member downward. Accordingly, the movable member presses the drive wheel downward through the first toggle mechanism and the frame. As a result, it is made possible to apply a wheel load with a sufficient magnitude to the drive wheel.

A carrying vehicle according to a second aspect relates to the carrying vehicle according to the first aspect and is configured as follows. The operating member includes an operating lever. The operating lever is attached to the frame in a pivotable manner. The first toggle mechanism includes a third link and a second joint. The third link is attached to the first and second links through the first joint. The second joint joins the third link and the operating lever therethrough to each other.

A carrying vehicle according to a third aspect relates to the carrying vehicle according to the first or second aspect and is configured as follows. The operating member includes an operating lever disposed on a first side of the first toggle mechanism. The first joint is located on the first side of an imaginary reference line when the first toggle mechanism is set in the unactuated state. The imaginary reference line is defined as an imaginary line connecting a first pivot axis of the first link and a second pivot axis of the second link. The joint is located either on the imaginary reference line or on a second side of the imaginary reference line when the first toggle mechanism is set in the actuated state.

A carrying vehicle according to a fourth aspect relates to the carrying vehicle according to any of the first to third aspects and is configured as follows. The frame includes a pillar extending in an up-and-down direction. The movable member is attached to the pillar in a manner movable up and down. The arm is attached to the pillar in a manner movable up and down.

A carrying vehicle according to a fifth aspect relates to the carrying vehicle according to any of the first to fourth aspects and is configured as follows. The arm is attached to the frame in a manner pivotable in a horizontal direction but not pivotable in an up-and-down direction.

A carrying vehicle according to a sixth aspect relates to the carrying vehicle according to any of the first to fifth aspects and is configured as follows. The elastic member is disposed to overlap with the drive wheel in a back-and-forth direction.

A carrying vehicle according to a seventh aspect relates to the carrying vehicle according to any of the first to sixth aspects and is configured as follows. The first toggle mechanism is disposed to overlap with the drive wheel in a back-and-forth direction.

A carrying vehicle according to an eighth aspect relates to the carrying vehicle according to any of the first to seventh aspects and is configured as follows. The joint mechanism includes a base unit, a first clamp member, a second clamp member, and a second toggle mechanism. The first clamp member includes a pressure receiving surface oriented upward or downward. The first clamp member is attached to the base unit in an immovable manner. The second clamp member includes a pressure applying surface opposed to the pressure receiving surface. The second clamp member is attached to the base unit in a manner movable up and down. The second toggle mechanism is configured to move the second clamp member up and down. The second toggle mechanism is switchable between an actuated state and an unactuated state. The second toggle mechanism causes the pressure applying surface to press the pressure receiving surface when set in the actuated state. The second toggle mechanism releases the pressure applying surface from pressing the pressure receiving surface when set in the unactuated state. The operating member is configured to switch the second toggle mechanism between the actuated state and the unactuated state.

Overall, according to the present invention, it is made possible to apply a wheel load with a sufficient magnitude to a drive wheel.

### BRIEF DESCRIPTION OF THE DRAWINGS

FIG. 1 is a side view of a carrying vehicle.

FIG. 2 is a side view of the carrying vehicle, from which a frame is detached in part.

FIG. 3 is an enlarged cross-sectional view of the carrying vehicle focusing on a movable member in a condition where the movable member is located on an upper side.

FIG. 4 is a front view of a clamp device, by which an object has not been clamped.

FIG. 5 is a rear view of the clamp device, by which the object has not been clamped.

FIG. 6 is a side view of the clamp device, by which the object has not been clamped.

FIG. 7 is a rear view of the clamp device, by which the object has been clamped.

FIG. 8 is a front view of the clamp device, by which the object has been clamped.

FIG. 9 is a side view of the clamp device, by which the object has been clamped.

FIG. 10 is a side view of the carrying vehicle, from which the frame is detached in part, and by which the object has not been clamped.

FIG. 11 is a side view of a first toggle mechanism set in an actuated state and peripheral members thereof.

FIG. 12 is a side view of the first toggle mechanism set in an unactuated state and the peripheral members thereof.

FIG. 13 is an enlarged front view of the carrying vehicle seen from a front side when an operating member is located in a retracted position.

FIG. 14 is an enlarged front view of the carrying vehicle seen from the front side when the operating member is located in a deployed position.

FIG. 15 is an enlarged cross-sectional view of the carrying vehicle focusing on the movable member in a condition where the movable member is located on a lower side.

### DETAILED DESCRIPTION

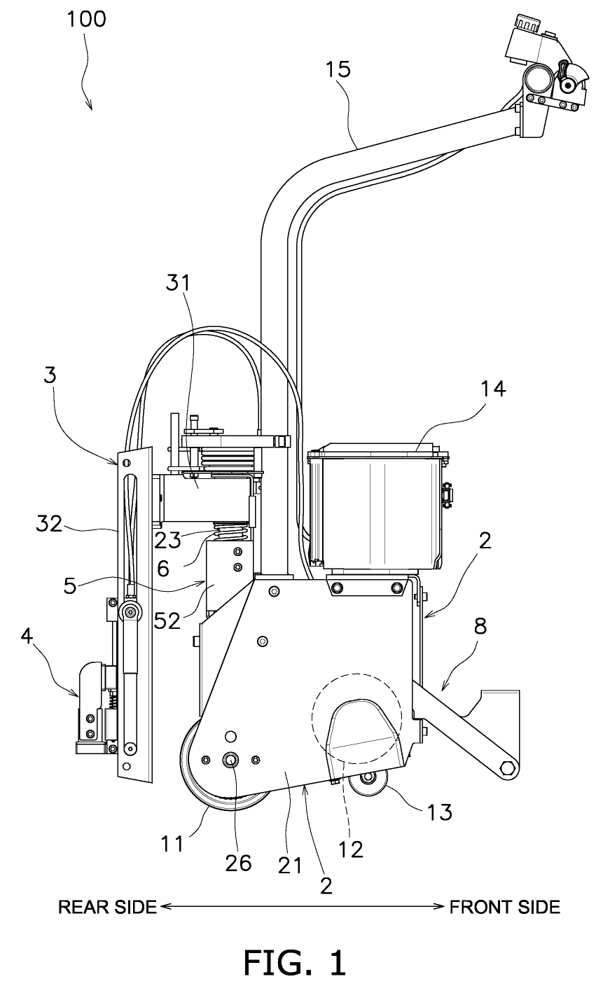

A carrying vehicle 100 according to the present preferred embodiment will be hereinafter explained with reference to drawings. It should be noted that in the following explanation, the term “front” refers to a direction that the carrying vehicle 100 is moved, while towing a carried vehicle (omitted in illustration), whereas the term “rear” refers to a direction that the carrying vehicle 100 is moved, while pushing the carried vehicle. In other words, the right side in FIG. 1 corresponds to the front side, whereas the left side in FIG. 1 corresponds to the rear side. Besides, the term “width direction” refers to a direction oriented orthogonal to the drawing of FIG. 1.

### Carrying Vehicle

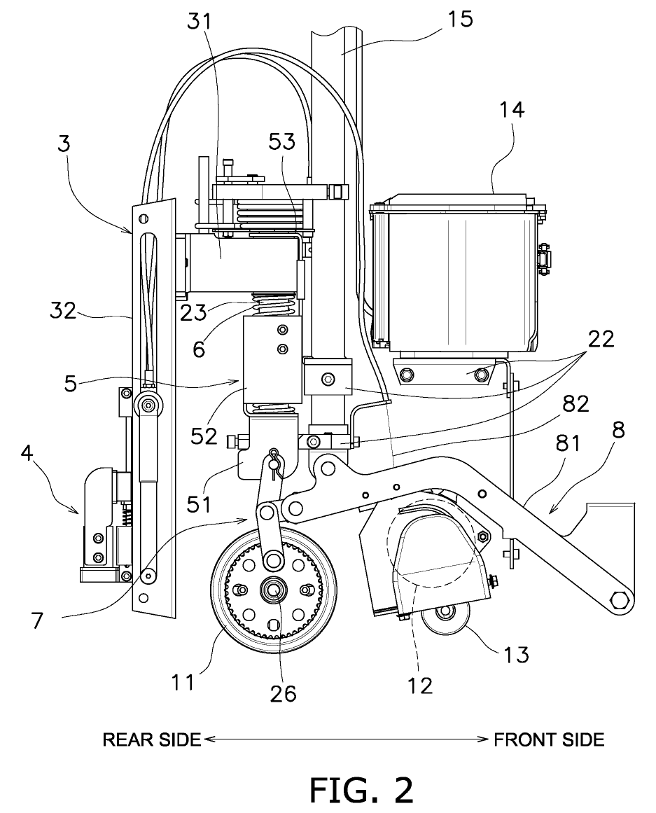

FIG. 1 is a side view of the carrying vehicle 100, whereas FIG. 2 is a side view of the carrying vehicle 100, from which a frame 2 is detached in part. It should be noted that FIGS. 1 and 2 show the carrying vehicle 100, in which a clamp device 4 is set in a clamping state, although joining to the carried vehicle has not been made. As shown in FIGS. 1 and 2, the carrying vehicle 100 is configured to be joined to the carried vehicle so as to tow the carried vehicle. It should be noted that the carried vehicle is disposed on the rear side (the left side in FIG. 1) of the carrying vehicle 100.

The carrying vehicle 100 is driven by a human drive force and an assist force generated by a prime mover 12. It should be noted that the carrying vehicle 100 is capable of traveling only by either the human drive force or the drive force generated by the prime mover 12. A variety of vehicles, including a cage cart, a cart, a stretcher, a wheelchair, and so forth, can be exemplified as the carried vehicle. The carrying vehicle 100 includes the frame 2, an arm 3, the clamp device 4 (exemplary joint mechanism), a movable member 5, an elastic member 6, a first toggle mechanism 7, and an operating member 8. Besides, the carrying vehicle 100 includes a drive wheel 11, the prime mover 12, one or more driven wheels 13, a battery 14, and a handle post 15.

### Frame

The frame 2 supports the drive wheel 11, the prime mover 12, the one or more driven wheels 13, the battery 14, and the handle post 15.

The frame 2 includes a pair of side plates 21, a plurality of coupling members 22, and a pillar 23. The pair of side plates 21 is disposed away from each other at an interval in a width direction. The drive wheel 11 and the prime mover 12 are disposed between the pair of side plates 21.

The coupling members 22 are disposed between the pair of side plates 21. The coupling members 22 extend between the pair of side plates 21 in the width direction. The coupling members 22 couple the pair of side plates 21 therethrough to each other. The coupling members 22 are attached to the pair of side plates 21 by, for example, bolts or so forth.

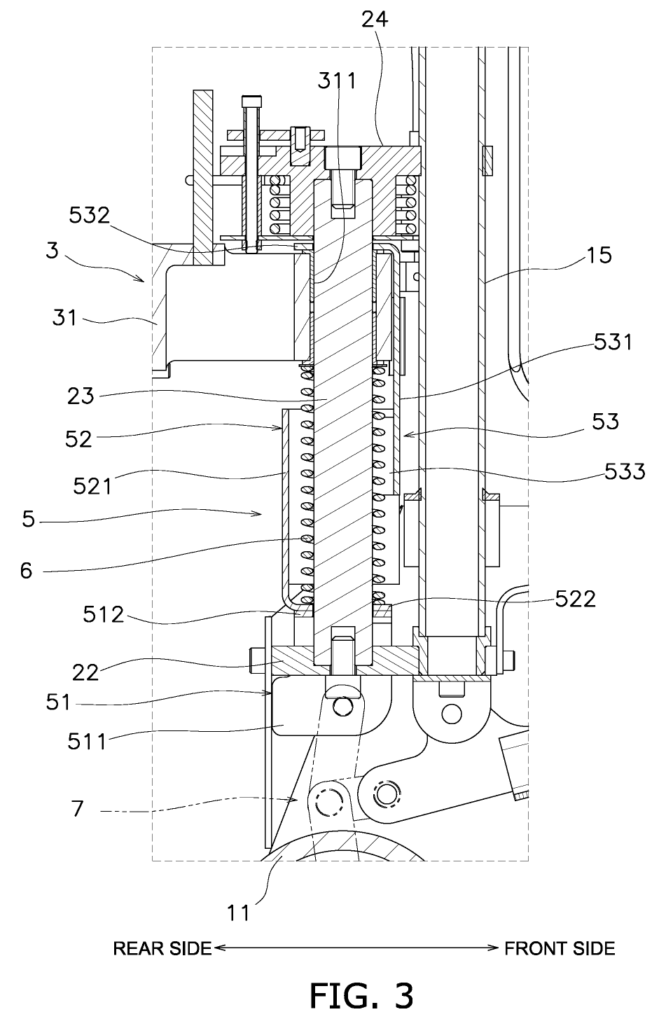

FIG. 3 is an enlarged cross-sectional view of the carrying vehicle 100. As shown in FIGS. 1 to 3, the pillar 23 extends in an up-and-down direction. The pillar 23 is fixed to one of the coupling members 22. When described in detail, the pillar 23 is fixed at a lower end portion thereof to the aforementioned one of the coupling members 22. The pillar 23 is fixed at an upper end portion thereof to a support member 24 fixed to the handle post 15. In other words, the pillar 23 is fixed at the upper end portion thereof to the frame 2 through the support member 24 and the handle post 15. The pillar 23 is moved unitarily with the pair of side plates 21 and the coupling members 22.

The handle post 15 is attached to the frame 2. When described in detail, the handle post 15 is fixed to the frame 2 and is moved unitarily therewith. The handle post 15 is configured to receive the human drive force forwardly or rearwardly inputted thereto by a user. For example, a handle to be held by the user is attached to a distal end portion of the handle post 15.

The drive wheel 11, the prime mover 12, the one or more driven wheels 13, and the battery 14 are attached to the frame 2. The drive wheel 11 is attached to the frame 2 in a rotatable manner. When described in detail, the frame 2 includes a shaft 26. The shaft 26 extends between the pair of side plates 21 in the width direction. The drive wheel 11 is attached to the shaft 26. The drive wheel 11 is rotated unitarily with the shaft 26. The shaft 26 is attached to the pair of side plates 21 in a rotatable manner. It should be noted that the shaft 26 may be attached to the pair of side plates 21 in a non-rotatable manner. In this case, the drive wheel 11 is attached to the shaft 26 in the rotatable manner.

The prime mover 12 drives the drive wheel 11. The prime mover 12 is, for instance, an electric motor. The prime mover 12 is supplied with electricity from the battery 14.

### Arm

The arm 3 is attached to the frame 2. The arm 3 is movable with respect to the frame 2 in the up-and-down direction. The arm 3 is attached to the pillar 23 of the frame 2. When described in detail, the arm 3 is attached to the pillar 23 in a manner movable up and down. Besides, the arm 3 is attached to the pillar 23 in a pivotable manner. The arm 3 is attached to the frame 2 in a manner pivotable in a horizontal direction. On the other hand, the arm 3 is not pivotable with respect to the frame 2 in the up-and-down direction.

The arm 3 includes a first arm portion 31 and a second arm portion 32. The first arm portion 31 extends rearward from the pillar 23. The first arm portion 31 includes a through hole 311 penetrating therethrough in the up-and-down direction; then, the pillar 23 extends inside the through hole 311. Because of this, the first arm portion 31 is made movable along the pillar 23 in the up-and-down direction.

The second arm portion 32 extends downward from the distal end (the rear end) of the first arm portion 31. The second arm portion 32 is moved unitarily with the first arm portion 31. In other words, the second arm portion 32 is pivoted unitarily with the first arm portion 31 and is also moved unitarily therewith in the up-and-down direction.

### Clamp Device

The clamp device 4 is attached to the arm 3. When described in detail, the clamp device 4 is attached to the second arm portion 32 of the arm 3. The clamp device 4 is attached to the arm 3 in a manner adjustable in position in the up-and-down direction. For example, the clamp device 4 is fixed to the arm 3 by a plurality of bolts, a quick release lever, or so forth and is made movable with respect to the arm 3 in the up-and-down direction by loosening the bolts, the lever, or so forth.

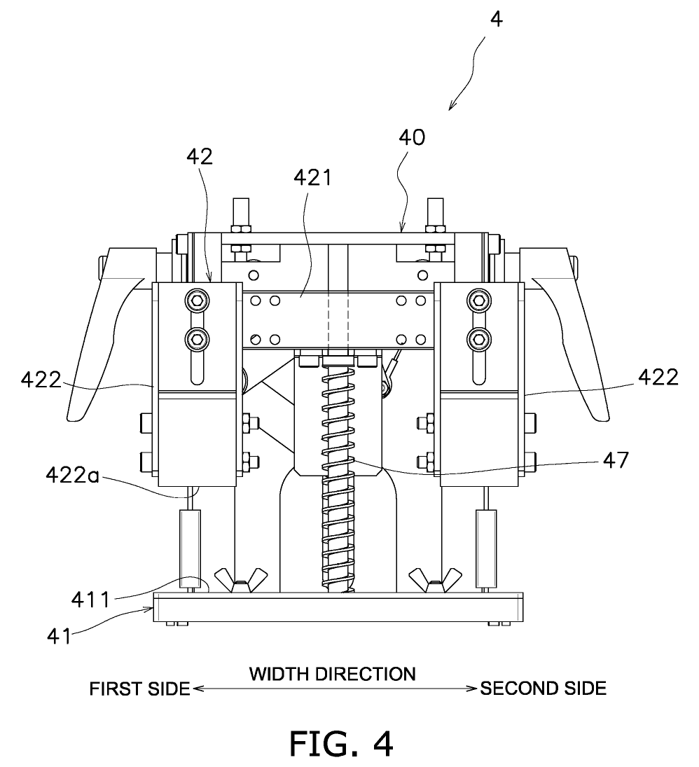

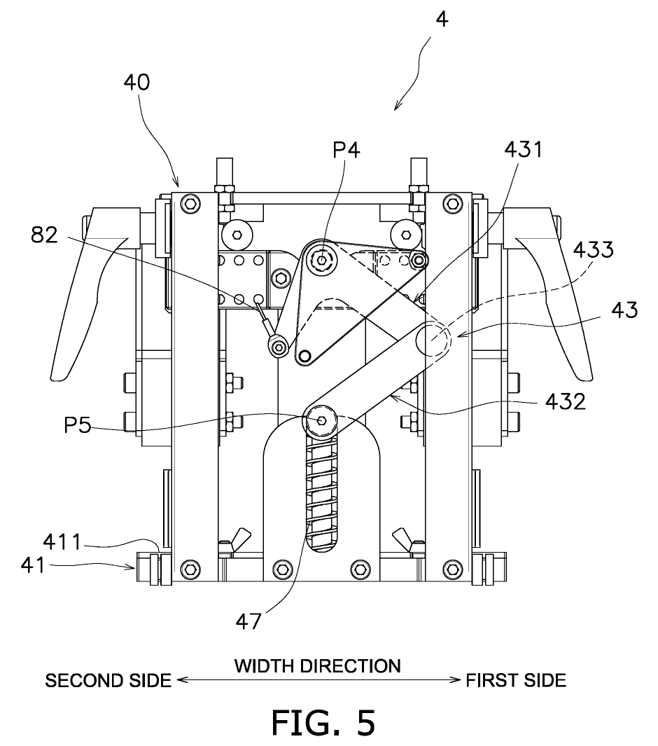

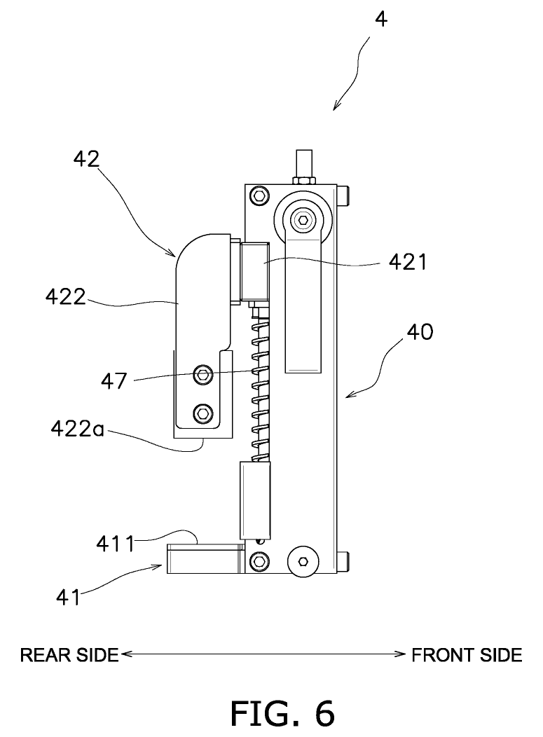

FIG. 4 is a front view of the clamp device 4 seen from the rear side; FIG. 5 is a rear view of the clamp device 4 seen from the front side; FIG. 6 is a side view of the clamp device 4. FIGS. 4 to 6 show the clamp device 4, by which an object has not been clamped.

As shown in FIGS. 4 to 6, the clamp device 4 is configured to clamp a part of the carried vehicle (i.e., an object). The clamp device 4 clamps an outer peripheral part of the carried vehicle. The clamp device 4 includes a base unit 40, a first clamp member 41, a second clamp member 42, and a second toggle mechanism 43.

The base unit 40 is attached to the arm 3 in a manner adjustable in position in the up-and-down direction.

The first clamp member 41 is fixed to the base unit 40. In other words, the first clamp member 41 is attached to the base unit 40 in an immovable manner. The first clamp member 41 is moved unitarily with the base unit 40.

The first clamp member 41 includes a pressure receiving surface 411. The pressure receiving surface 411 is oriented upward. The pressure receiving surface 411 extends in both the width direction and a back-and-forth direction.

The second clamp member 42 is attached to the base unit 40 in a manner movable in the up-and-down direction. The second clamp member 42 includes a slider 421 and a pair of clamp bodies 422.

The slider 421 is attached to the base unit 40 in a manner movable up and down. The pair of clamp bodies 422 is attached to both ends of the slider 421, respectively. Each clamp body 422 includes a pressure applying surface 422a. The pressure applying surface 422a is oriented downward. The pressure applying surface 422a is opposed to the pressure receiving surface 411. The object (W), composing a part of the carried vehicle, is clamped by the pressure applying surfaces 422a and the pressure receiving surface 411, whereby the carrying vehicle 100 and the carried vehicle are joined to each other.

An urging member 47 urges the second clamp member 42 such that the pressure applying surfaces 422a are separated away from the pressure receiving surface 411. Specifically, the urging member 47 urges the second clamp member 42 upward.

The second toggle mechanism 43 is configured to move the second clamp member 42 up and down. The second toggle mechanism 43 includes a fourth link 431, a fifth link 432, and a third joint 433.

The fourth link 431 is attached to the base unit 40 in a pivotable manner. The fourth link 431 is pivotable about a fourth pivot axis P4.

The fifth link 432 is attached to the second clamp member 42 in a pivotable manner. The fifth link 432 is pivotable about a fifth pivot axis P5. The pivot axis P5 is disposed immediately below the fourth pivot axis P4 in the up-and-down direction.

The third joint 433 joins the fourth and fifth links 431 and 432 therethrough to each other. The third joint 433 is movable in both the up-and-down direction and the width direction.

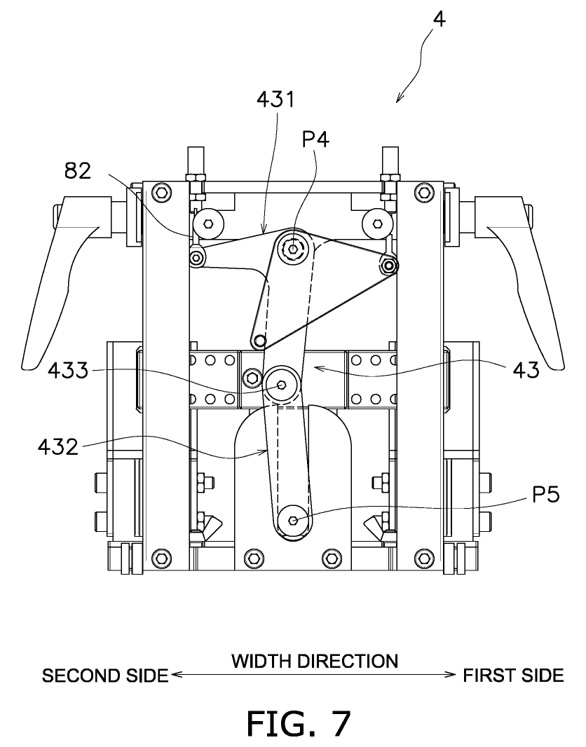

FIG. 7 is a rear view of the clamp device 4, by which the object W has been clamped. As shown in FIGS. 5 and 7, the second toggle mechanism 43 is switchable between an actuated state and an unactuated state. It should be noted that FIG. 5 shows the unactuated state of the second toggle mechanism 43, whereas FIG. 7 shows the actuated state of the second toggle mechanism 43.

As shown in FIG. 5, when set in the unactuated state, the second toggle mechanism 43 moves the second clamp member 42 upward such that the pressure applying surfaces 422a are separated away from the pressure receiving surface 411. Accordingly, the pressure applying surfaces 422a are released from pressing the pressure receiving surface 411, whereby the first and second clamp members 41 and 42 are released from clamping the object W.

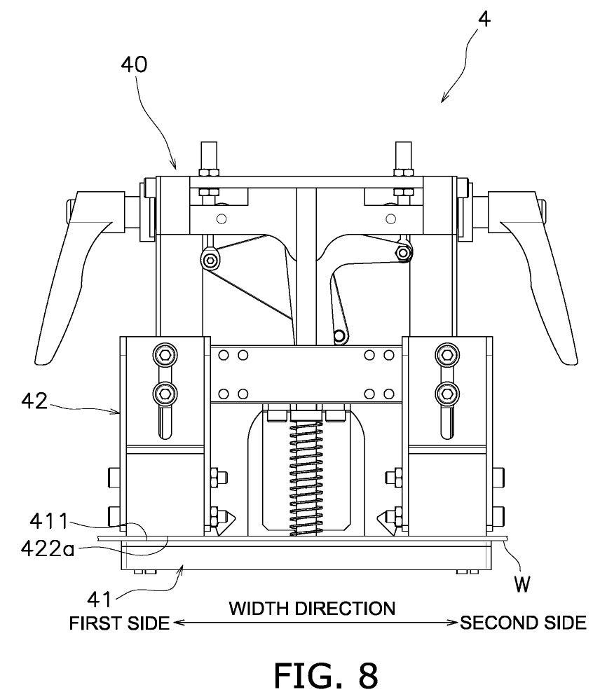

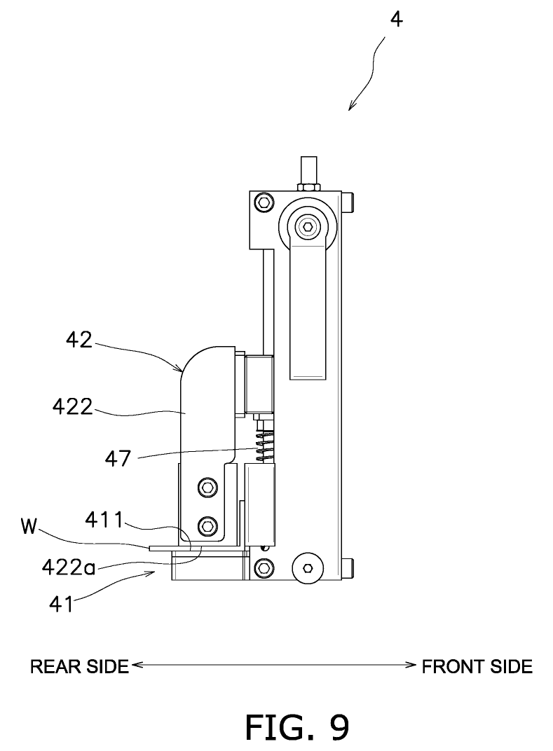

As shown in FIG. 7, when set in the actuated state, the second toggle mechanism 43 moves the second clamp member 42 downward. Consequently, as shown in FIGS. 8 and 9, the pressure applying surfaces 422a press the pressure receiving surface 411 through the object W, whereby the object W is clamped by the first and second clamp members 41 and 42.

### Movable Member

As shown in FIGS. 1 to 3, the movable member 5 is attached to the frame 2 in a manner movable in the up-and-down direction. When described in detail, the movable member 5 is attached to the pillar 23 of the frame 2 in a manner movable in the up-and-down direction.

The movable member 5 includes a first movable part 51, a second movable part 52, and a third movable part 53. The first, second, and third movable parts 51, 52, and 53 are configured to be moved unitarily with each other.

The first movable part 51 is configured to sandwich the aforementioned one of the coupling members 22 therein in the width direction. When described in detail, the first movable part 51 includes a pair of side plate portions 511 and a top plate portion 512. The first movable part 51 opens downward, forward, and rearward.

The pair of side plate portions 511 is disposed away from each other at an interval in the width direction. The aforementioned one of the coupling members 22 is disposed between the pair of side plate portions 511. The top plate portion 512 joins the upper ends of the pair of side plate portions 511. The top plate portion 512 includes a through hole. The pillar 23 extends to penetrate the through hole.

The second movable part 52 includes a side plate portion 521 and a bottom plate portion 522. The second movable part 52 opens forward and upward. The side plate portion 521 extends in the up-and-down direction, while enclosing the pillar 23 at an interval therefrom. It should be noted that the front side of the pillar 23 is not covered with the side plate portion 521.

The bottom plate portion 522 is disposed on the top plate portion 512 of the first movable part 51. The bottom plate portion 522 is joined to the top plate portion 512. It should be noted that the bottom plate portion 522 may not be joined to the top plate portion 512. The bottom plate portion 522 includes a through hole. The through hole of the bottom plate portion 522 communicates with that of the top plate portion 512. The pillar 23 extends in the up-and-down direction through the through hole of the top plate portion 512 and that of the bottom plate portion 522.

The third movable part 53 includes a side plate portion 531, a top plate portion 532, and a pair of coupling portions 533. The side plate portion 531 is disposed on the front side of the pillar 23.

The top plate portion 532 extends rearward from the upper end of the side plate portion 531. The top plate portion 532 is disposed above the arm 3. When described in detail, the top plate portion 532 is disposed above the first arm portion 31 of the arm 3. The top plate portion 532 includes a through hole. The pillar 23 extends through the through hole in the up-and-down direction. Thus, the pillar 23 extends in the up-and-down direction to penetrate the through hole of the first movable part 51, that of the second movable part 52, and that of the third movable part 53; hence, the movable member 5 is made movable along the pillar 23 in the up-and-down direction.

The pair of coupling portions 533 is disposed away from each other at an interval in the width direction. The pillar 23 is disposed between the pair of coupling portions 533. The pair of coupling portions 533 extends rearward from the lower end of the side plate portion 531. The pair of coupling portions 533 is coupled to the second movable part 52 by bolts and/or so forth.

### Elastic Member

As shown in FIG. 3, the elastic member 6 is disposed between the arm 3 and the movable member 5 in the up-and-down direction. The elastic member 6 is in contact at an upper end portion thereof with the arm 3, while being in contact at a lower end portion thereof with the movable member 5. When described in detail, the elastic member 6 is in contact at the upper end portion thereof with the first arm portion 31. The elastic member 6 is in contact at the lower end portion thereof with the bottom plate portion 522 of the second movable part 52. When compressed, the elastic member 6 urges the arm 3 upward, while urging the movable member 5 downward. The elastic member 6 is, for instance, a coil spring.

The elastic member 6 is disposed in a gap between the pillar 23 and the movable member 5. The pillar 23 extends inside the elastic member 6 in the up-and-down direction, while penetrating the elastic member 6. The elastic member 6 is disposed to overlap with the drive wheel 11 in the back-and-forth direction. In other words, the elastic member 6 and the drive wheel 11 are identical in position in the back-and-forth direction. The elastic member 6 is disposed immediately above the drive wheel 11.

### First Toggle Mechanism

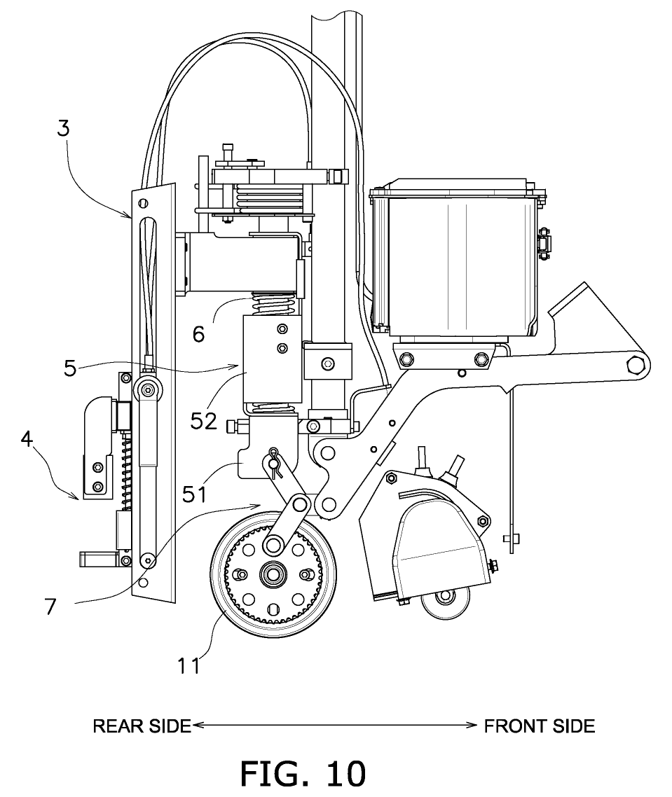

FIG. 10 is a diagram corresponding to FIG. 2 in an unactuated state of the first toggle mechanism 7. As shown in FIGS. 2 and 10, the first toggle mechanism 7 is configured to move the movable member 5 up and down. The first toggle mechanism 7 is switchable between the actuated state and an unactuated state. As shown in FIG. 2, when set in the actuated state, the first toggle mechanism 7 moves the movable member 5 upward. As shown in FIG. 10, when set in the unactuated state, the first toggle mechanism 7 moves the movable member 5 downward.

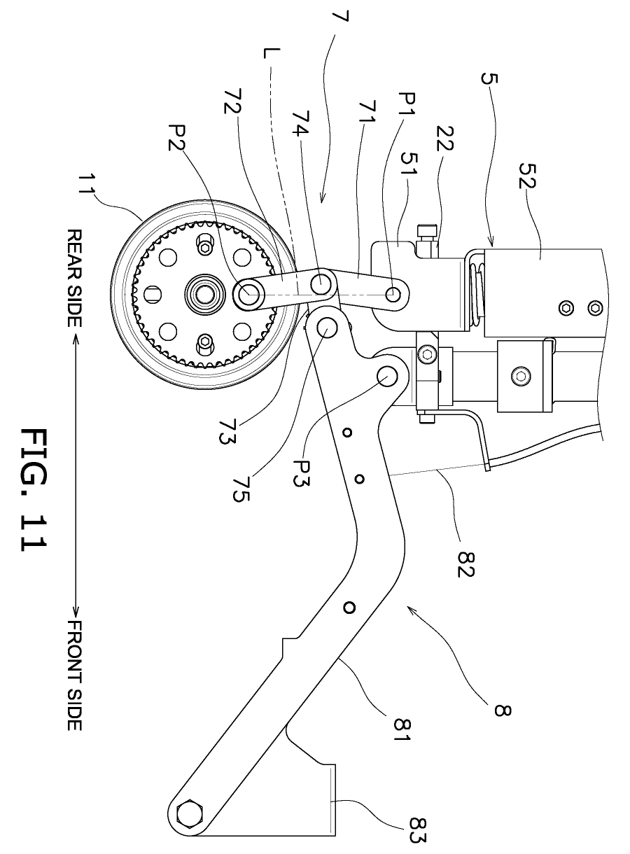

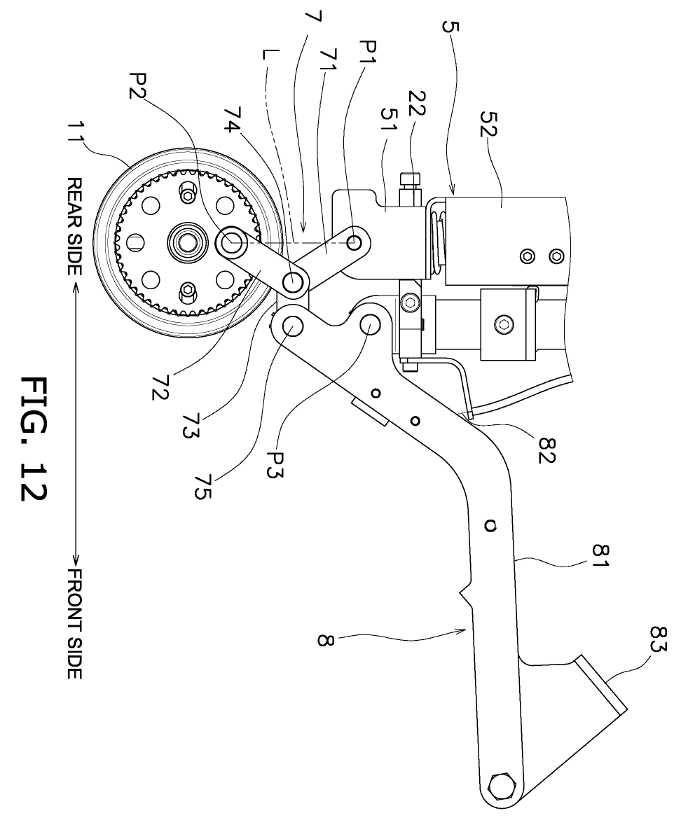

FIGS. 11 and 12 are enlarged views of the carrying vehicle 100 focusing on the first toggle mechanism 7. FIG. 11 shows the actuated state of the first toggle mechanism 7, whereas FIG. 12 shows the unactuated state of the first toggle mechanism 7. Besides, FIGS. 11 and 12 omit illustration of members unnecessary for explanation.

As shown in FIGS. 11 and 12, the first toggle mechanism 7 is disposed to overlap with the drive wheel 11 in the back-and-forth direction. In other words, the first toggle mechanism 7 and the drive wheel 11 are identical in position in the back-and-forth direction. The first toggle mechanism 7 includes a first link 71, a second link 72, a third link 73, a first joint 74, and a second joint 75.

The first link 71 is attached to the movable member 5 in a pivotable manner. When described in detail, the first link 71 is attached at an upper end portion thereof to the first movable part 51 in a pivotable manner. The first link 71 is pivotable about a first pivot axis P1.

The second link 72 is disposed below the first link 71. The second link 72 is attached to the frame 2 in a pivotable manner. When described in detail, the second link 72 is attached at a lower end portion thereof to the pair of side plates 21 in a pivotable manner. The second link 72 is pivotable about a second pivot axis P2. The second pivot axis P2 is disposed immediately below the first pivot axis P1 in the up-and-down direction. An imaginary line, connecting the first and second pivot axes P1 and P2, will be referred to as an imaginary reference line L.

The first joint 74 joins the first and second links 71 and 72 therethrough to each other. The first joint 74 is movable in both the up-and-down direction and the width direction. When the first toggle mechanism 7 is set in the actuated state, the first joint 74 is located either on the imaginary reference line L or on the rear side (an exemplary second side) of the imaginary reference line L; Contrarily, when the first toggle mechanism 7 is set in the unactuated state, the first joint 74 is located on the front side (an exemplary first side) of the imaginary reference line L. When the first toggle mechanism 7 is set in the actuated state, the first and second pivot axes P1 and P2 are disposed away from each other at a larger distance than when the first toggle mechanism 7 is set in the unactuated state.

The third link 73 is attached to the first and second links 71 and 72 through the first joint 74. The third link 73 extends forward from the first joint 74. The second joint 75 joins the third link 73 and an operating lever 81 (to be described) therethrough to each other.

### Operating Member

The operating member 8 is configured to switch the first toggle mechanism 7 between states. Specifically, the operating member 8 switches the first toggle mechanism 7 between the actuated state and the unactuated state. Besides, the operating member 8 is configured to switch the second toggle mechanism 43 between states. The operating member 8 includes the operating lever 81, a wire 82, and a pedal 83.

The operating lever 81 is disposed on the front side (the exemplary first side) of the first toggle mechanism 7. The operating lever 81 is attached to the frame 2 in a pivotable manner. When described in detail, the operating lever 81 is attached to the coupling members 22 in a pivotable manner. The operating lever 81 is pivotable about a third pivot axis P3.

The operating lever 81 is joined to the third link 73 through the second joint 75. The operating lever 81 is joined at a rear end portion thereof to the third link 73. The operating lever 81 is forwardly exposed at a front end portion thereof from the frame 2. When the front end portion of the operating lever 81 is operated by the user with the foot or so forth, the operating lever 81 is pivoted about the third pivot axis P3.

The wire 82 joins the operating lever 81 and the fourth link 431 therethrough to each other. When the operating lever 81 is pivoted to turn the first toggle mechanism 7 to the actuated state, the wire 82 pulls the fourth link 431. Accordingly, the fourth link 431 is pivoted about the fourth pivot axis P4, whereby the second toggle mechanism 43 is turned to the actuated state. For example, a Bowden cable is provided as the wire 82.

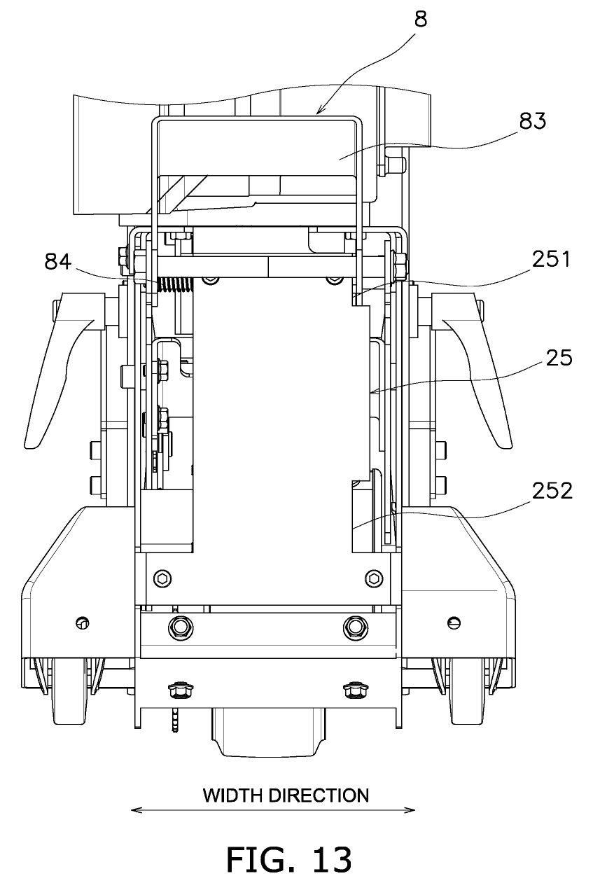

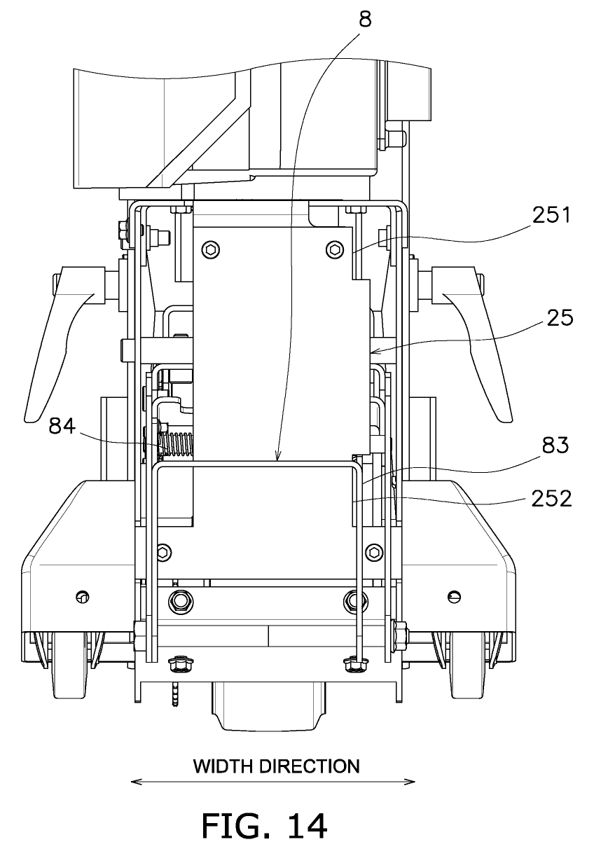

The pedal 83 is attached to the front end portion of the operating lever 81. The operating member 8 is operated when the pedal 83 thereof is trodden down by the user. As shown in FIGS. 13 and 14, the pedal 83 is movable in the width direction with respect to the operating lever 81. The operating lever 81 is being urged to one side in the width direction by a spring or so forth provided as an urging member 84 so as to return to the one side in the width direction. In the present preferred embodiment, the pedal 83 is being urged to the left side as seen from the front side. FIGS. 13 and 14 are front views of the carrying vehicle 100 seen from the front side. It should be noted that FIG. 13 shows the operating member 8 set in a retracted position, whereas FIG. 14 shows the operating member 8 set in a deployed position.

The frame 2 includes a holding plate 25. The holding plate 25 includes a first indented portion 251 and a second indented portion 252. The first indented portion 251 is disposed above the second indented portion 252.

When the carrying vehicle 100 is not being used, the operating member 8 is set in the retracted position. When the operating member 8 is set in the retracted position, the pedal 83 in part is disposed in the first indented portion 251. Accordingly, the operating member 8 is restricted from moving downward. When the carrying vehicle 100 is used with the carried vehicle being joined thereto, the operating member 8 is set in the deployed position. When the pedal 73 is moved to the other side in the width direction (the right side in FIGS. 13 and 14) so as to be disengaged from the first indented portion 251 and is then trodden down, the operating member 8 is moved to the deployed position. The pedal 83 is moved to the one side in the width direction by the urging force and is thereby accommodated in the second indented portion 252. Thus, when the operating member 8 is set in the deployed state, the pedal 83 in part is disposed in the second indented portion 252. Accordingly, the operating member 8 is restricted from returning to the upper side.

### Actions

As shown in FIG. 12, when the carrying vehicle 100 is not being used, the operating member 8 is set in the retracted position. When the operating member 8 is set in the retracted position, the front end portion thereof is kept being raised upward. Besides, the operating member 8 keeps the first joint 74 moved forward through the third link 73. Because of this, the first toggle mechanism 7 is turned to the unactuated state and keeps the movable member 5 moved downward.

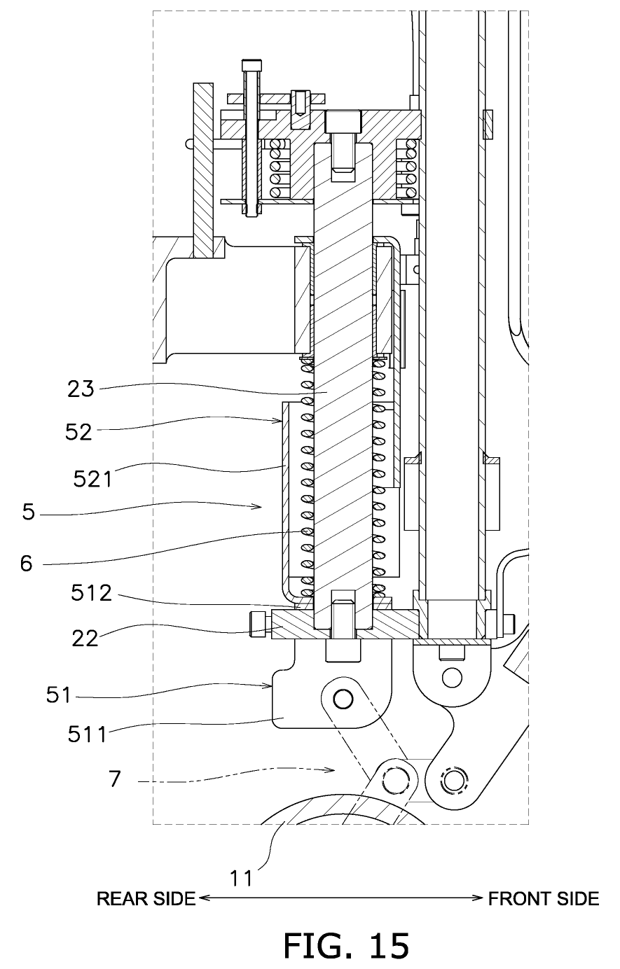

As shown in FIG. 15, the elastic member 6 is not being compressed, while the movable member 5 is kept being moved downward. It should be noted that the elastic member 6 may be compressed. The movable member 5 is in contact with the aforementioned one of the coupling members 22. When described in detail, the movable member 5 is in contact at the top plate portion 512 of the first movable part 51 thereof with the aforementioned one of the coupling members 22.

On the other hand, when the operating member 8 is set in the retracted position, the wire 82 is not being pulled by the operating lever 81. Because of this, the second toggle mechanism 43 is set in the unactuated state, whereby the clamp device 4 is not clamping the object W.

As shown in FIG. 11, when the pedal 83 is trodden down to pivot the operating member 8 to the deployed position, the operating member 8 moves the first joint 74 rearward through the third link 73. Accordingly, the first toggle mechanism 7 is turned to the actuated state, whereby the movable member 5 is moved upward.

When moved upward, the movable member 5 presses the elastic member 6 upward as shown in FIG. 3. Here, the clamp device 4 is not clamping the carried vehicle in FIG. 3; hence, the elastic member 6 is kept from being moved upward together with the arm 3. Contrarily, when the clamp device 4 is clamping the carried vehicle, the weight of the carried vehicle acts on the arm 3; hence, the arm 3 is not moved upward. Because of this, the elastic member 6, disposed between the arm 3 and the movable member 5, is compressed, whereby the elastic force of the elastic member 6 is downwardly applied to the movable member 5. Alternatively, the elastic force of the elastic member 6, downwardly applied to the movable member 5, is increased in magnitude. As a result, the elastic member 6 presses the drive wheel 11 downward through the movable member 5, the first toggle mechanism 7, and the frame 2, whereby a wheel load with a sufficient magnitude acts on the drive wheel 11.

### Modifications

One preferred embodiment of the present invention has been explained above. However, the present invention is not limited to the above, and it will be apparent to one of ordinary skill in the art from this disclosure that a variety of changes can be made without departing from the gist of the present invention. It should be noted that basically speaking, respective modifications to be described are applicable separately or in combination in an embodiment.
(a) In the preferred embodiment described above, the second link 72 is attached to the pair of side plates 21; however, the second link 72 is not limited in configuration to this. For example, the second link 72 may be attached, not to the pair of side plates 21, but to the shaft 26 in a pivotable manner.
(b) In the preferred embodiment described above, the clamp device 4 has been exemplified as the joint mechanism; however, the joint mechanism is not limited in configuration to this. Any suitable member or members may be employed as the joint mechanism as long as the carrying vehicle 100 is thereby made joinable to the carried vehicle. For example, the carrying vehicle 100 may be joined to the carried vehicle by a bolt or bolts and/or so forth.
(c) In the preferred embodiment described above, the operating member 8 is configured to be operated by the user with the foot; however, the operating member 8 is not limited in configuration to this. For example, the operating member 8 may be disposed in a suitable position so as to be operated by the user with the hand.

### LIST OF REFERENCE NUMERALS

2: Frame , 23: Pillar, 3: Arm, 4: Clamp device, 40: Base unit, 41: First clamp member, 411: Pressure receiving surface, 42: Second clamp member, 422a: Pressure applying surface, 43: Second toggle mechanism, 5: Movable member, 6: Elastic member, 7: First toggle mechanism, 71: First link, 72: Second link, 73: Third link, 74: First joint, 75: Second joint, 9: Operating member, 81: Operating lever, 11: Drive wheel, 12: Prime mover, 100: Carrying vehicle, L: Imaginary reference line, P1: First pivot axis, P2: Second pivot axis.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “plurality,” as used herein, can encompass the configuration in which each element of a plurality of elements has a different shape or structure from each other in addition to the configuration in which the plurality of elements have the same shapes or structures as each other.

The terms “a” (or “an”), “one or more” and “at least one” can be used interchangeably herein. The phrase “at least one of” as used in this disclosure means “one or more” of a desired choice.

Terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Modifications and variations of the present invention will be apparent to one of ordinary skill in the art in light of this disclosure. It is therefore to be understood that within the scope of the appended claims, the invention may be practiced otherwise than as specifically described herein.

1. A carrying vehicle comprising:
a frame;
a drive wheel rotatably attached to the frame;
a prime mover configured to drive the drive wheel;
an arm operably connected to the frame to permit up and down movement;
a joint mechanism attached to the arm, the joint mechanism configured to be joined to a carried vehicle;
a movable member operably coupled to the frame to permit up and down movement;
an elastic member disposed between the arm and the movable member;
a first toggle mechanism switchable between an actuated state and an unactuated state, the first toggle mechanism including a first link, a second link, and a first joint, the first link being pivotably attached to the movable member, the second link being pivotably attached to the frame, the first joint joining the first and second links therethrough to each other; and
an operating member configured to switch the first toggle mechanism between the actuated state and the unactuated state,
the first toggle mechanism being configured to move the movable member upward in the actuated state and downward in the unactuated state.

2. The carrying vehicle according to claim 1, wherein
the operating member includes an operating lever that is pivotably attached to the frame, and
the first toggle mechanism includes a third link and a second joint, the third link attached to the first and second links through the first joint, the second joint joining the third link and the operating lever therethrough to each other.

3. The carrying vehicle according to claim 1, wherein
the operating member includes an operating lever disposed on a first side of the first toggle mechanism,
the first joint is located on the first side of an imaginary reference line when the first toggle mechanism is set in the unactuated state, the imaginary reference line defined as an imaginary line connecting a first pivot axis of the first link and a second pivot axis of the second link, and
the first joint is located either on the imaginary reference line or on a second side of the imaginary reference line when the first toggle mechanism is set in the actuated state.

4. The carrying vehicle according to claim 1, wherein
the frame includes a pillar extending in an up-and-down direction,
the movable member is operably mounted at the pillar to permit up and down movement, and
the arm is operably mounted at the pillar to permit up and down movement.

5. The carrying vehicle according to claim 1, wherein the arm is coupled to the frame in a configuration enabling the arm to pivot in a horizontal direction but not pivote in an up-and-down direction.

6. The carrying vehicle according to claim 1, wherein the elastic member is disposed to overlap with the drive wheel in a back-and-forth direction.

7. The carrying vehicle according to claim 1, wherein the first toggle mechanism is disposed to overlap with the drive wheel in a back-and-forth direction.

8. The carrying vehicle according to claim 1, wherein
the joint mechanism includes
a base unit,
a first clamp member including a pressure receiving surface oriented upward or downward, the first clamp member is immovably attached to the base unit,
a second clamp member including a pressure applying surface opposed to the pressure receiving surface, the second clamp member is operably mounted to the base unit to permit up and down movement, and
a second toggle mechanism configured to move the second clamp member up and down, the second toggle mechanism switchable between an actuated state and an unactuated state, the second toggle mechanism causing the pressure applying surface to press the pressure receiving surface when set in the actuated state, the second toggle mechanism releasing the pressure applying surface from pressing the pressure receiving surface when set in the unactuated state, and
the operating member is configured to switch the second toggle mechanism between the actuated state and the unactuated state.

9. The carrying vehicle according to claim 2, wherein
the operating member includes an operating lever disposed on a first side of the first toggle mechanism,
the first joint is located on the first side of an imaginary reference line when the first toggle mechanism is set in the unactuated state, the imaginary reference line defined as an imaginary line connecting a first pivot axis of the first link and a second pivot axis of the second link, and
the first joint is located either on the imaginary reference line or on a second side of the imaginary reference line when the first toggle mechanism is set in the actuated state.

10. The carrying vehicle according to claim 2, wherein
the frame includes a pillar extending in an up-and-down direction,
the movable member is operably mounted at the pillar to permit up and down movement, and
the arm is operably mounted at the pillar to permit up and down movement.

11. The carrying vehicle according to claim 3, wherein
the frame includes a pillar extending in an up-and-down direction,
the movable member is operably mounted at the pillar to permit up and down movement, and
the arm is operably mounted at the pillar to permit up and down movement.

12. The carrying vehicle according to claim 2, wherein the arm is coupled to the frame in a configuration enabling the arm to pivot in a horizontal direction but not pivot in an up-and-down direction.

13. The carrying vehicle according to claim 3, wherein the arm is coupled to the frame in a configuration enabling the arm to pivot in a horizontal direction but not pivot in an up-and-down direction.

14. The carrying vehicle according to claim 4, wherein the arm is coupled to the frame in a configuration enabling the arm to pivot in a horizontal direction but not pivot in an up-and-down direction.

15. The carrying vehicle according to claim 2, wherein the elastic member is disposed to overlap with the drive wheel in a back-and-forth direction.

16. The carrying vehicle according to claim 3, wherein the elastic member is disposed to overlap with the drive wheel in a back-and-forth direction.

17. The carrying vehicle according to claim 4, wherein the elastic member is disposed to overlap with the drive wheel in a back-and-forth direction.

18. The carrying vehicle according to claim 5, wherein the elastic member is disposed to overlap with the drive wheel in a back-and-forth direction.

19. The carrying vehicle according to claim 2, wherein the first toggle mechanism is disposed to overlap with the drive wheel in a back-and-forth direction.

20. The carrying vehicle according to claim 3, wherein the first toggle mechanism is disposed to overlap with the drive wheel in a back-and-forth direction.
